(19) United States
(12) Patent Application Publication
(10) Pub. No.: US 2002/0135448 A1
(43) Pub. Date: Sep. 26, 2002

(54) Segmented armature for magnetically actuated switch

(76) Inventor: Anthony J. Van Zeeland, Mesa, AZ (US)

Correspondence Address: DURASWITCH, 234 S. EXTENSION, SEC. 103, MESA, AZ, 85210, US

(21) Appl. No.: 09/812,669

(22) Filed: Mar. 20, 2001

(51) Int. Cl. H01H 9/00

(52) U.S. Cl. 335/207

(57) ABSTRACT

An electrical switch has a conductive armature moved into and out of electrical connection with electrical conductors formed on a nonconductive carrier layer. The armature is moved by a user-activated coupler magnet mounted on the side of the carrier layer opposite the armature and electrical conductors. The armature is made of magnetic material and includes at least two segments joined together in electrical contact by a linking member. The armature may be a section of bead chain wherein hollow armature segments are joined by conductive axles.

### BACKGROUND OF THE INVENTION

Magnetically actuated switches provide a compact, reliable and durable switching function. These switches offer a very slim profile, low weight, economical assembly, and are used in an increasing number of applications in a variety of environments. They combine the tactile feel of a bulky mechanical switch with the compactness of a conventional membrane switch. Magnetically actuated switches of this general type are shown and described in U.S. Pat. Nos. 5,523,730, 5,666,096 and 5,867,082, the disclosures of which are incorporated herein by reference. While magnetically actuated switches already have many applications, it is advantageous to expand the applications of such switches even further, and the present invention is directed to a new type of armature for magnetically actuated switches.

A magnetically actuated switch of the type involved in the present invention includes a carrier layer having first and second surfaces. A set of electrical conductors is formed on the first surface thereof. The term “electrical conductors” is intended to include electrodes, resistor elements, or spaced contacts or pads. Electrical leads suitably connect the electrical conductors to external electronics. The electrical conductors are arranged so that a conductive armature is movable into and out of engagement with the electrical conductors. Engagement of the armature with the electrical conductors will electrically connect them and cause switch closure. The armature rolls on the first surface of the carrier layer. A coupler is mounted on the second surface of the carrier layer, opposite the electrical conductors and armature. The coupler is a permanent magnet. The armature is made of magnetic material. By magnetic material it is meant that the material is affected by a magnet. The magnetic attraction between the coupler and the armature holds the armature in engagement with the carrier layer. An actuating force applied to the coupler by a user causes corresponding movement of the armature, either into or out of electrical connection with the electrical conductors.

The patents mentioned above describe an armature made of twin balls or spheres. The twin ball armature has distinct advantages including the ability to travel freely in any direction, ready availability of balls in the commercial marketplace, ease of plating the balls, and the ability of the balls to roll rather than slide, particularly when turning comers. There are, however, some situations where improved resistance to very large, unexpected and abnormal external acceleration of the switch would be desirable.

### SUMMARY OF THE INVENTION

The present invention concerns an armature for a magnetically actuated switch. The armature has at least two segments that are conductive and made of magnetic material. The segments are held in electrical contact with one another by a linking member. The armature may be a section of bead chain, with hollow spheres as segments and conductive axles that extend into the spheres as linking members. The switch includes a coupler on the surface of the carrier layer opposite the armature and electrical conductors. The coupler is a permanent magnet. Movement of the coupler by a user causes the armature to follow the coupler, The linking member may be either integrally formed in the segments or it can be a separate piece, such as an axle, disposed in passages through the segments. The linking member is preferably made of electrically conductive material.

### BRIEF DESCRIPTION OF THE DRAWINGS

FIG. 1 is a plan view of a prior art switch having twin ball armatures on a two-bit encoder.

FIG. 2 is a plan view of a prior art switch having a twin ball armature on a potentiometer.

FIG. 3 is a partial sectional view of a switch having a bead chain armature according to the present invention.

FIG. 4 is a partial sectional view of a switch having a segmented armature according to the present invention.

FIG. 5 is a side elevation view of a switch having armature segments made of permanent magnets according to the present invention.

FIG. 6 is a sectional view of an alternate embodiment of a segmented armature according to the present invention.

FIG. 7 is a sectional view of a further alternate form of segmented armature.

FIG. 8 is an end elevation view of the armature of FIG. 7.

FIG. 9 is a sectional view of a further alternate form of segmented armature.

FIG. 10 is an end elevation view of the armature of FIG. 9.

FIG. 11 is a sectional view of a further alternate form of armature having an integral linking member.

FIG. 12 is an end elevation view of the armature of FIG. 11

FIG. 13 is a side elevation view of yet another alternate form of armature with an integral linking member.

FIG. 14 is an end elevation view of the armature of FIG. 13.

### DETAILED DESCRIPTION OF THE INVENTION

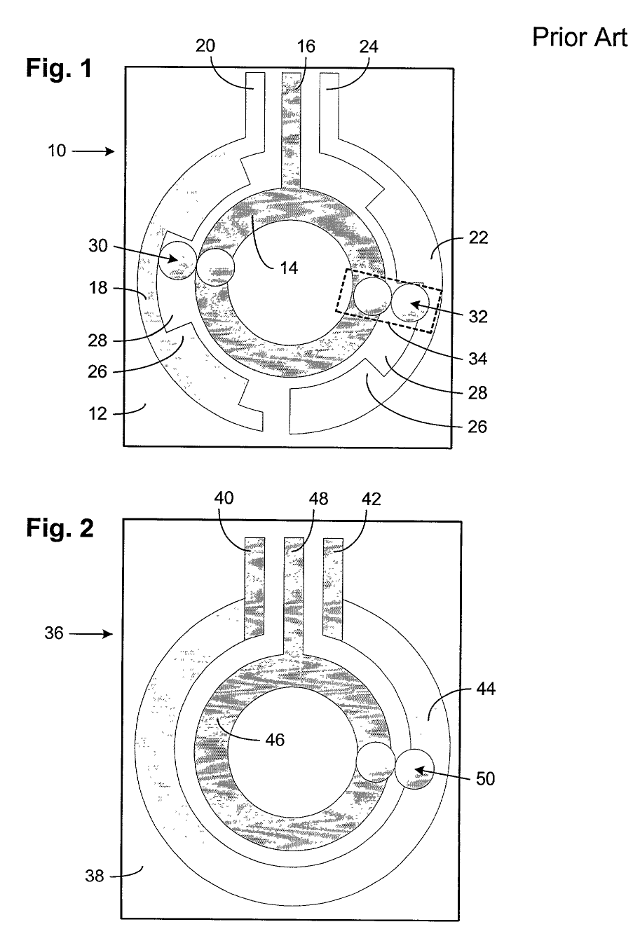

When designing a magnetically actuated switch of the type having a twin ball armature, the diameter of the balls determines the spacing between the switch's electrical conductors. This is the case whether the switch is using a simple two-bit quadrature encoder or an analog potentiometer. The center-to-center distance between balls becomes even more important when designing three, four and five bit encoders. FIG. 1 shows a switch 10 in the form of a two-bit encoder. It has a carrier layer 12 with a set of electrical conductors 14, 18, 22 formed on the first surface thereof. The carrier layer is made of a nonconductive material and may be either rigid or flexible, depending on the environment in which the switch will be used. Printed circuit board material and polyester are examples of acceptable substrate materials for the carrier layer. The electrical conductors are made of conductive materials that may be painted, printed, etched or otherwise formed on the first surface of the carrier layer. In this case the electrical conductors include a circular, common electrical conductor 14 with a lead 16, an A output electrical conductor 18 with a lead 20, and a B output electrical conductor 22 with a lead 24. It will be understood that the leads extend to a suitable connector, typically at an edge of the carrier layer, for connection to external electronics. The external electronics supply the electrical signals on the leads 16, 20, 24 and electrical conductors 14, 18, 22 that are switched by electrically connecting the electrical conductors together. Note also that the electrical conductors 18 and 22 are generally circular with a discontinuous inside diameter. This forms pad areas 26 which are separated from one another by open areas 28.

The switch 10 of FIG. 1 includes two armatures 30 and 32 of the twin ball type. The balls are conductive and made of magnetic material. They are magnetically held against the first surface of the carrier layer 12 by two couplers, one of which is shown diagrammatically at 34. The couplers are mounted on the second surface of the carrier layer. The coupler is a magnet, or multiple magnets. It may be affixed to a knob (not shown) which is mounted for either rotational or sliding motion on the carrier layer. It will be understood that the switch may commonly include additional components not shown here, such as a substrate, a spacer, and a dome and/or membrane to enclose and protect the basic switch elements as shown. Movement of the coupler, or the knob that carries the coupler, will cause corresponding movement of the armature. That is, the armature will follow the coupler. In the switch of FIG. 1 it is intended that the coupler will rotate and carry the armatures 30 and 32 in a circular pattern.

FIG. 2 illustrates a similar switch whose electrical conductors are laid out in the form of a potentiometer 36. The potentiometer has a carrier layer 38 on which are formed high and low voltage leads 40 and 42 on either end of a circular carbon resistor element 44. Inside the resistor element is a wiper 46 connected to a wiper lead 48 that extends out between the high and low voltage leads. A twin ball armature 50 spans the gap between the resistor element 44 and the wiper 46. A coupler (not shown) is on the second surface of the carrier layer, aligned with the armature 50. Again it is intended that the coupler will rotate and carry the armature 50 in a circular pattern.

As can be seen in the electrical conductor layout of FIG. 1, the segments of the armatures move in and out of electrical connection between the electrical conductors 18 and 22 and the common electrical conductor 14. When the balls are in the open areas 28 there is no electrical connection, but when the balls are opposite the pad areas 26 there is contact between the electrical conductors 18 and 22 and the common electrical conductor 14. Similarly, in FIG. 2 the armature 50 bridges the gap between the resistor element 44 and the wiper 46. When either the switch 10 or potentiometer 36 is manufactured, spacing of the electrical conductors becomes very important when printing tolerances and assembly tolerances are taken into consideration. If the switch is assembled slightly out of center, for example, the balls might not touch the electrical conductors in certain portions of the rotation cycle. To increase the spacing between the electrical conductors, the ball diameter would have to be increased which presents other problems.

The attractive force the coupler magnet exerts on the balls drops off rapidly as the distance from the magnet to each ball's center of mass increases. More force is needed to hold a ball with a larger mass and larger diameter because the center of mass is farther from the magnet's attractive force. This physical limitation would result in an unstable armature if the balls were too big and heavy for the magnet to carry. The armatures of the present invention are designed to address these issues.

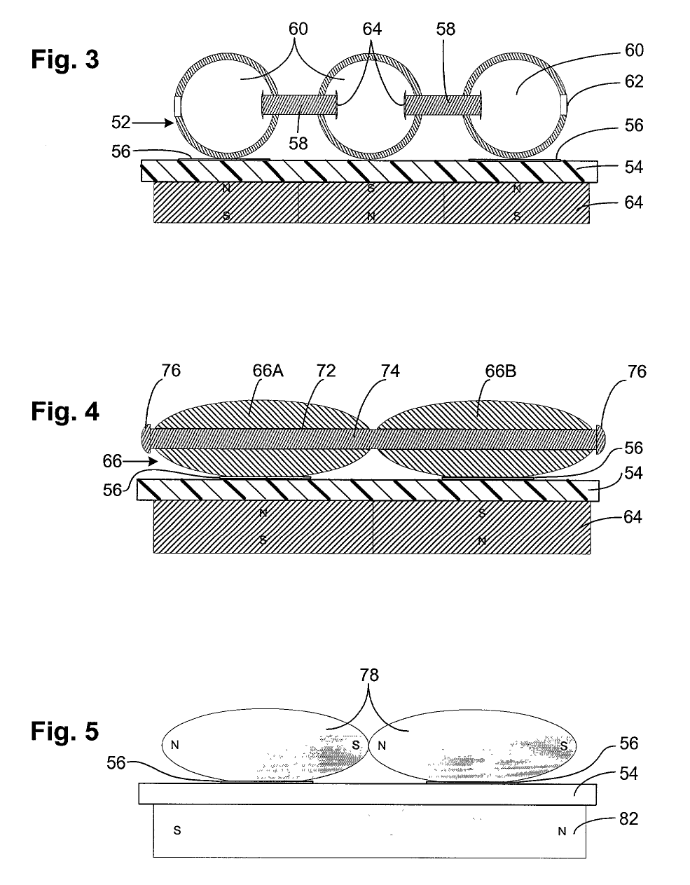

In FIG. 3 the armature 52 of the present invention is a section of bead chain. It is illustrated on top of a carrier layer 54 with coupler magnets 64. It will be understood that suitable electrical conductors 56, e.g., those of FIGS. 1 or 2, would be formed on the first surface of the carrier layer. The linking member is at least one rod or axle 58 that passes through passages 62 in the segments 60. The axles have flared ends 64 that prevent the segments 60 from sliding off the axle 58. One axle links two segments together such that the segments are able to rotate with respect to one another. Axles are electrically conductive and hold the segments in electrical contact with one another. It is preferable that the axles are made of a magnetic material, but this need not be the case.

Bead chain is readily available, inexpensive, and is offered in various sizes and materials. Bead chain is commonly known for its use in the military to hold identity disks. Bead chain is manufactured in many different metals that are affected by a magnet and offer good conductivity. As an armature, the hollow spheres of bead chain act as individual segments that freely rotate about at least one axle. Each axle is shared by two segments. The axles in bead chain are flared at the ends to keep the segments together, but the flared ends are inside the hollow spheres. Bead chain can easily be cut to any length, making it suitable for use as a two, three, or more segmented armature.

The bead chain armature features lower weight and decreased distance between the magnetic material of the armature and the coupler magnet, resulting in a stronger bond by the magnetic force of the coupler. This armature also provides increased ability to prevent dislodging because a segment cannot be individually separated from the coupler magnet by an external acceleration. If one segment is in a weakly bonded position as an external acceleration is applied, a more strongly magnetically held segment is linked to and holds the segment. Also, an external acceleration cannot change the configuration of a chain of armature segments.

In FIG. 4, an alternate armature 66 of the present invention is illustrated. In this embodiment, the armature 66 comprises two armature segments 66A and 66B, each with an axial passage 72 extending through them. The segments are prolate spheroids. A linking member 74 extends through the segments 66A and 66B. The linking member is a rod or axle having flared ends 76 which prevent the segments 66 from sliding off the axle 74. The arrangement of segments joined by axles could be especially useful for automated assembly because the individual armatures can be cut to length as needed. In this case, the ends of the axle could be flared as they are cut to prevent separation of the segments and axle.

In FIG. 5 the segments are permanent magnets, eliminating the need for an axle to link the segments. The attractive force of the permanent magnet segments 78 acts as the linking member when opposing poles of two segments are brought together. The coupler 82 may be a permanent magnet mounted on the second surface of the carrier layer 54. The coupler magnet should be aligned such that the poles of the single coupler magnet align with the opposing poles formed at the far ends of the armature. The surface of the armature should be sufficiently conductive to electrically connect the electrical conductors 56.

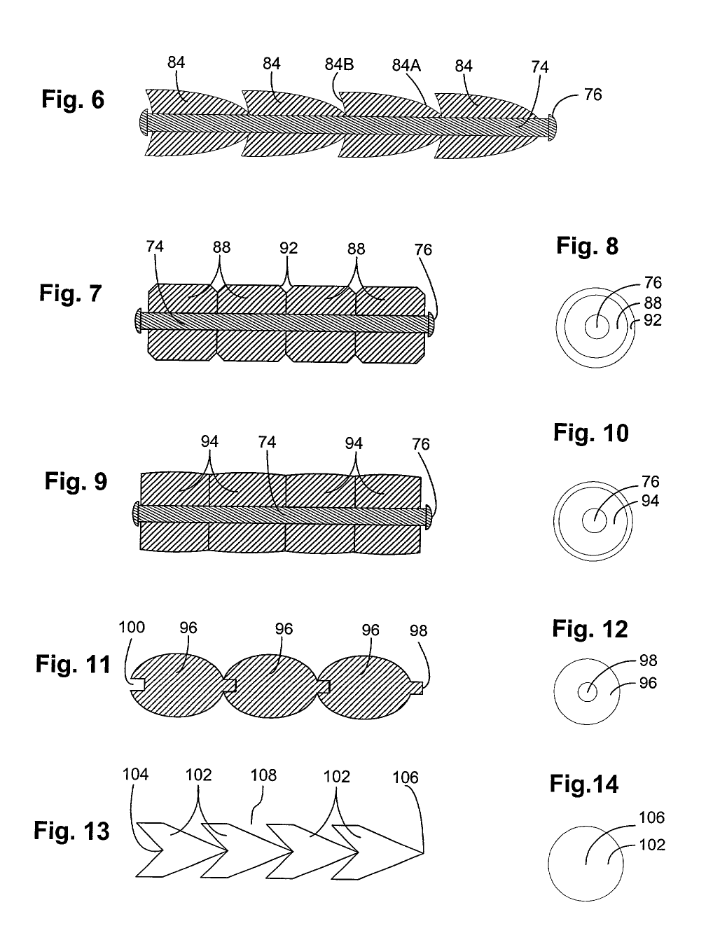

In FIG. 6 an alternate shape for the armature segments is shown. An end view of this version would be similar to that shown in FIG. 12. This armature has segments 84 that are joined by an axle 74 having flared ends 76. These segments 84 have a shape that might be described as an undercut prolate spheroid. That is, one end 84A has a prolate spheroid shape while the other end 84B has a concave shape. This shape is chosen for ease of manufacture. A commonly used process for making the prolate spheroidal shape of the segments in FIG. 4 is cold heading. Cold heading is a process wherein the part is formed by a forging die hitting a blank at each end. This process invariably forms a so-called witness line around the center of the formed shape. A witness line at the center would be exactly where a prolate spheroid segment engages the electrical conductors, which could cause premature wear of the electrical conductors. The witness line is removable by a secondary rolling or milling process. Alternatively, the shape of the FIG. 6 undercut prolate spheroid segments is such that the witness line is moved to the end of the part during the forming operation. The undercut shape eliminates the need for a secondary process during manufacture.

FIGS. 7 and 8 show a further alternate segment shape. Here the segments 88 are joined by an axle 74 having flared ends 76. These segments 88 are essentially little cylinders with chamfered comers 92 joining the end faces and cylindrical surfaces. The segments 94 in FIGS. 9 and 10 are similar except the chamfers are deleted and the segments have a slightly bowed cross section giving the segments something of a barrel shape. Again an axle 74 having flared ends 76 joins and holds the segments together.

FIGS. 11 and 12 present a further variation wherein the linking member is integrally formed in the armature segments. These segments 96 are prolate spheroids that have a socket 100 at one end and a plug 98 at the other. The plug of one segment fits into the socket of an adjoining segment to link the segments together somewhat in the nature of a chain. Preferably, the plug and socket are sized such that one segment can rotate relative to its adjacent segment.

FIGS. 13 and 14 illustrate an alternate form where the armature segments have an integral linking member. Here the segments have a cross section in the nature of a chevron. Each chevron 102 has a V-shaped cavity 104 on one side and a projection 106 on the other. The projection on one segment fits into the cavity on an adjacent segment, except at the ends on the armature. The angle defined by the surfaces of the cavity 104 is greater than the internal angle between the surfaces the projection 106. This creates a gap 108 between the segments on the carrier layer. The gap on the carrier layer is needed to build an encoder, like the ones in FIGS. 1 and 2. The segments can rotate relative to one another to allow the armature to turn a comer or roll in a circular direction.

It will be understood that any of the armatures of FIGS. 3-14 could be used with the electrical conductors of FIGS. 1 or 2 or any desired variation thereof.

While a preferred form of the invention has been shown and described, it will be realized that alterations and modifications may be made thereto without departing from the scope of the following claims. It will be understood that the term electrical circuit element as used herein is intended to encompass devices of the type described whose electrical conductors are arranged either for on-off operation, i.e., a switch, or for operation as a potentiometer. Also, it will be noted that the segments may be held by the linking member in physical contact with one another. Or, as in the case of the bead chain, the segments may float into and out contact with one another within limits imposed by the linking member so long as the linking member is electrically conductive and provides electrical continuity between the floating segments. Such floating segments are still considered “joined” for purposes of the present invention. Where the a linking member holds the segments in physical contact with one another such that electrical continuity is assured from one segment to the next, the linking member could be made of nonconductive material.

What is claimed is:

1. In an electrical circuit element of the type having a carrier layer with at least two electrical conductors and a conductive armature on one side of the carrier layer, a coupler mounted for movement on the other side of the carrier layer, one of the coupler and armature being a permanent magnet and the other being made of magnetic material such that the armature is held in engagement with the carrier layer for movement thereon by the magnetic attraction between the coupler and armature, the improvement comprising an armature including at least two segments joined to one another by a linking member.

2. The armature of claim 1 wherein the linking member is an axle.

3. The armature of claim 2 wherein the segments independently rotate about the axle.

4. The armature of claim 2 wherein the armature is a section of bead chain.

5. The armature of claim 1 wherein the linking member comprises a socket formed in one segment and a plug formed on a second segment which fits into the socket of said one segment.

6. The armature of claim 1 wherein the segments have a socket on one end and a plug on the other end.

7. The armature of claim 2 wherein the segments have a prolate spheroid shape and an axial passage therethrough which receives the axle.

8. The armature of claim 2 wherein the segments have an undercut spheroid shape and an axial passage therethrough which receives the axle.

9. The armature of claim 2 wherein the segments have a generally cylindrical shape and an axial passage therethrough which receives the axle.

10. The armature of claim 9 wherein the segments have chamfered edges.

11. The armature of claim 2 wherein the segments have a barrel shape and an axial passage therethrough which receives the axle.

12. The armature of claim 1 wherein the linking member is integrally formed in the segments.

13. The armature of claim 12 wherein the segments have a prolate spheroid shape and a socket on one end and a plug on the other end.

14. The armature of claim 12 wherein the segments have a chevron shape and a cavity on one end and a projection on the other end.

15. An electrical circuit element, comprising:
a carrier having first and second surfaces;
a set of conductors disposed on one of said carrier surfaces;
a coupler mounted for movement on the other surface of the carrier;
a conductive armature on said one surface of the carrier, one of the coupler and armature being a permanent magnet and the other being made of magnetic material such that the armature is held in engagement with the carrier for movement thereon by the magnetic attraction between the coupler and armature, the armature including at least two segments and a linking member joining the two segments to one another.

16. The switch of claim 15 wherein the linking member is an axle.

17. An electrical circuit element comprising a carrier layer with at least two electrical conductors and a conductive armature on one side of the carrier layer, a coupler mounted for movement on the other side of the carrier layer, the coupler and armature being permanent magnets such that the armature is held in engagement with the carrier layer for movement thereon by the magnetic attraction between the coupler and armature, the armature including at least two segments joined to one another by the magnetic attraction between them.

18. The armature of claim 17 wherein the segments have a prolate spheroid shape and an axial passage therethrough which receives the axle.
